(19) United States
(12) Patent Application Publication
(10) Pub. No.: US 2008/0257505 A1
(43) Pub. Date: Oct. 23, 2008

(54) ROLLER BLIND MECHANISM

(76) Inventor: Peter BRAYBROOK, Gloucester (GB)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/102,972

(22) Filed: Apr. 15, 2008

(30) Foreign Application Priority Data
Apr. 21, 2007 (GB) 0707740.7

(51) Int. Cl. E06B 9/56

(52) U.S. Cl. 160/321

(57) ABSTRACT

A roller blind mechanism 16 for winding and unwinding a rollable blind, comprises a support element 18, a drive sprocket 20 which is rotatably mounted on the support element 18 for transmitting rotational movement to a blind supporting member, and a manually-movable elongate flexible drive element 22 which includes a plurality of interlinked tooth-engaging elements 32. The drive sprocket 20 includes a plurality of flexible teeth 38 engagable with the tooth-engaging elements 32 of the flexible drive element 22.

This invention relates to a roller blind mechanism for winding and unwinding a rollable blind.

Roller blinds are well known, and generally comprise a sheet of blind material wound around an elongate supporting tube of circular lateral cross-section. The blind supporting tube is supported for rotational movement at each end by brackets fastenable to, typically wall, surfaces. One of the brackets houses a drive mechanism. The drive mechanism typically comprises a sprocket or gear fixed via an axle or hub to the blind supporting tube, and an endless ball chain entrained with the sprocket. A user pulls the ball chain, the balls engage between the teeth of the sprocket, and the sprocket thus rotates, causing the blind material to be wound or unfurled.

A single drive sprocket can be utilised for directly driving the blind supporting tube, or the sprocket can indirectly drive the blind supporting tube via reduction gearing in the case of larger or heavier roller blinds.

The ball chain consists of a plurality of spaced balls, adjacent balls being interlinked by a short thin connecting rod or element. The ball chain can be formed from various materials, such as brass, mild steel, stainless steel and plastics. A plastics ball chain can be formed such the balls are positioned with an accurate, low tolerance pitch. This is due to high moulding accuracies being easily achievable at low cost. However, plastics is a very light, low density material, and thus such a ball chain tends to tangle and twist very easily. This is inconvenient for the user, and therefore largely unacceptable.

Metal ball chains are produced with far less accuracy. Brass and mild steel can be relatively easily worked, and thus, although more expensive than plastics, accuracies in ball pitch, even though less than plastics, are seen as being acceptable though not ideal.

Stainless steel is a far harder material, and thus much more difficult to work. Stainless steel must be used with heavier roller blinds, for example in larger commercial environments rather than in smaller domestic environments, since other materials wear and break too easily. It is expensive to produce a stainless steel ball chain with a consistently accurate ball spacing pitch which is suitable for use with a drive sprocket.

The known drive sprocket is a one-piece, typically moulded plastics, device with a plurality of fixed rigid teeth. The teeth define shallow troughs therebetween. The depth of each trough is less than half the diameter of a ball of the ball chain, in order to allow the ball connecting element to pass over the crest of an adjacent tooth. Since a pitch of the teeth is fixed, the pitch of the balls of the ball chain must be accurate to allow take-up of the balls as the sprocket rotates.

Since the pitch of the balls of the metal ball chains is not particularly accurate, and especially in the case of a stainless steel ball chain, loading on the known drive sprocket occurs primarily at the sides, instead of being evenly distributed around the drive sprocket.

This non-uniform loading tends to cause the balls to ride up the adjacent teeth, and rub against an interior wall of a sprocket housing. This rubbing causes increased friction and wear, reducing the working life of the mechanism and making the mechanism more difficult to operate.

The increased friction also generates heat, causing lubrication within the mechanism to dry more quickly, thus shortening the life of the mechanism.

The present invention seeks to provide a solution to this problem.

According to a first aspect of the invention, there is provided a roller blind mechanism for winding and unwinding a rollable blind, the mechanism comprising a support element, a drive sprocket which is rotatably mounted on the support element for transmitting rotational movement to a blind supporting member, and a manually-movable elongate flexible drive element which includes a plurality of interlinked tooth-engaging elements, the drive sprocket including a plurality of flexible teeth engagable with the tooth-engaging elements of the flexible drive element.

Preferable and/or optional features of the first aspect of the invention are set forth in claims 2 to 14, inclusive.

According to a second aspect of the invention, there is provided a roller blind assembly comprising a sheet of blind material wound around an elongate tubular blind supporting member, a supporting bracket at one end of the blind supporting member by which the blind supporting member is rotatably supported, and a roller blind mechanism according to the first aspect of the invention at the other end for rotating the blind supporting member to wind and unwind the sheet of blind material.

The present invention will now be more particularly described, by way of example only, with reference to the accompanying drawings, in which:

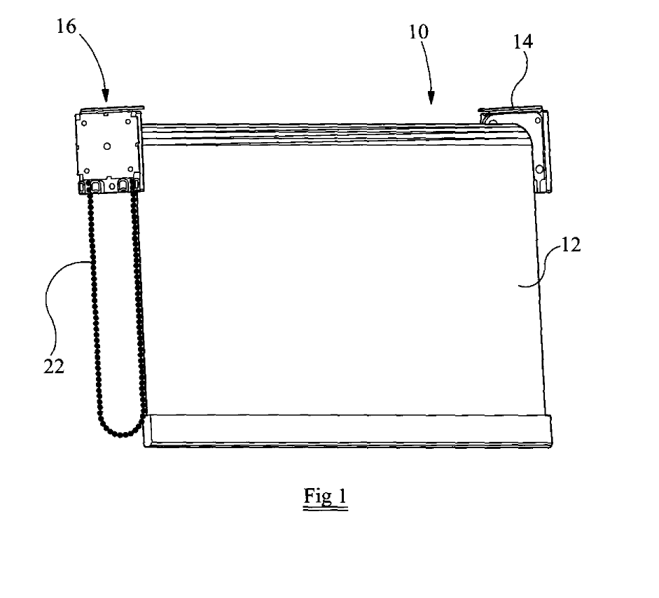

FIG. 1 shows a perspective view of a roller blind assembly including one embodiment of a roller blind mechanism, in accordance with the first aspect of the invention;

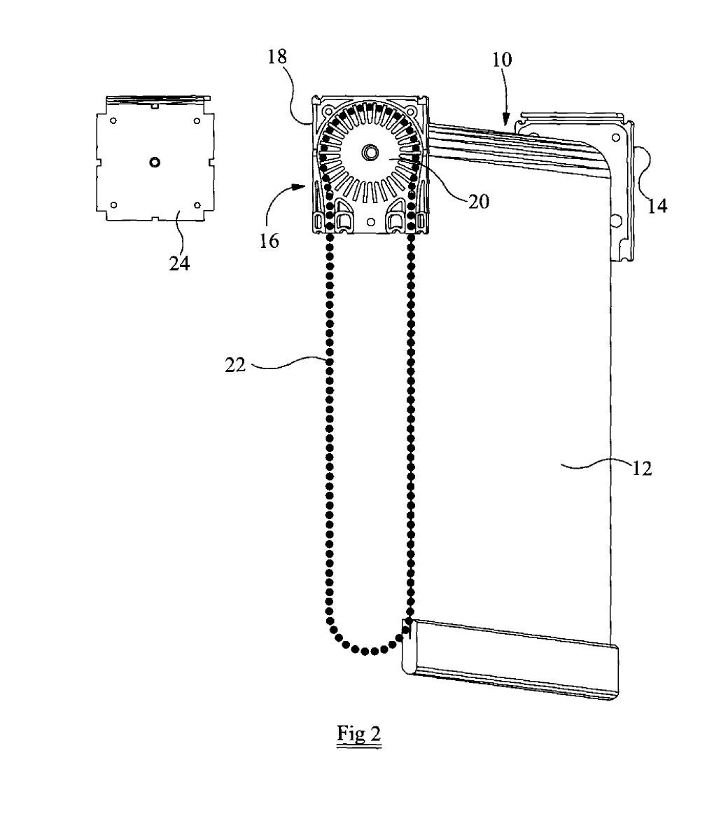

FIG. 2 shows the roller blind assembly of FIG. 1, with a cover plate of a drive sprocket housing removed to show a drive sprocket and ball chain;

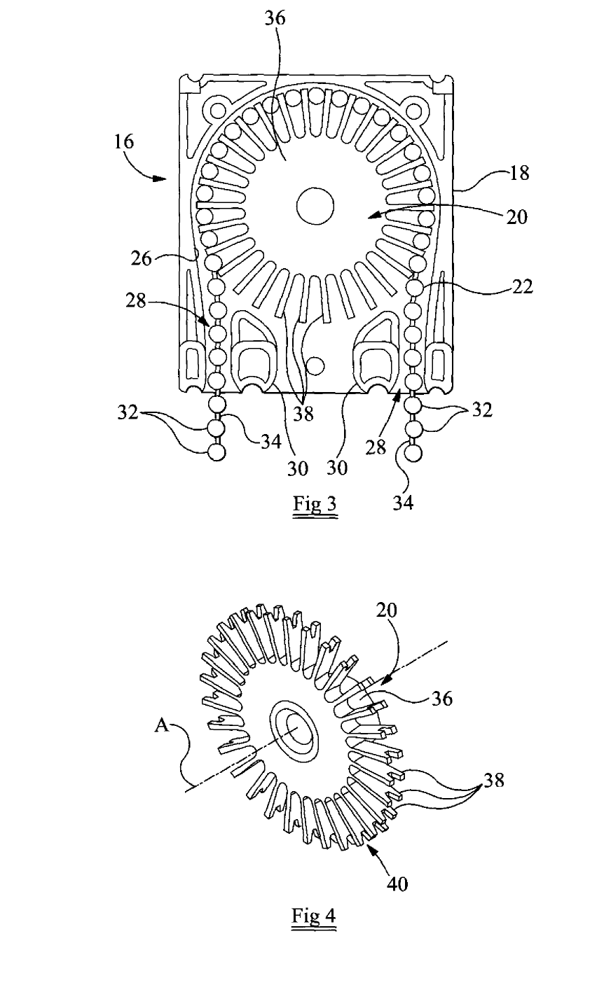

FIG. 3 shows an enlarged view of the drive sprocket and ball chain, shown in FIG. 2;

FIG. 4 shows a perspective view of the drive sprocket;

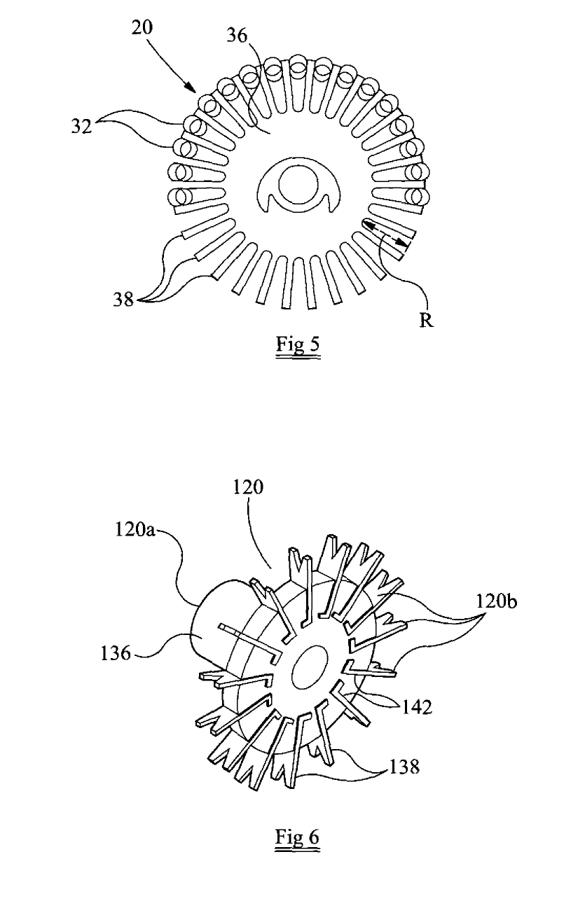

FIG. 5 shows a schematic view of the drive sprocket with balls of the ball chain located between teeth; and

FIG. 6 shows another drive sprocket of a second embodiment of a roller blind mechanism, according to the first aspect of the invention.

Referring firstly to FIGS. 1 to 5, there is shown a roller blind assembly 10 which comprises a sheet of blind material 12 wound around an elongate tubular blind supporting member (not shown) having a circular lateral cross-section, a supporting bracket 14 at one end of the blind supporting member to which the blind supporting member is rotatably engaged, and a first embodiment of a roller blind mechanism 16 at the other end for rotating the blind supporting member to wind and unwind the sheet of blind material 12.

The roller blind mechanism 16 comprises a sprocket supporting housing 18, a one-piece drive sprocket 20 which is rotatably mounted in the housing 18, and an endless elongate flexible drive chain 22.

The supporting housing 18 includes a removable cover plate 24 for substantially closing the housing 18. The housing 18 is typically formed from moulded plastics material, and includes an interior wall 26, a major portion of which extends in parallel with a circumference of the drive sprocket 20. Two guide channels 28 are also provided adjacent to a lower edge of the housing 18. Each guide channel 28 is formed by the interior wall 26 on one side and a projecting guide portion 30 on the other side.

The flexible drive chain 22 comprises a plurality of spaced balls 32 interlinked by connecting members 34. A pitch of the balls 32 is uniform or non-uniform with a tolerance up to and including plus or minus one and a half balls.

Preferably, the drive chain 22 is formed from stainless steel, but may be formed from any material, including metal, such as brass or mild steel, and plastics.

The drive sprocket 20 includes a sprocket body 36 which is fixedly engaged with the blind supporting member, and a plurality of elongate spaced flexible teeth 38 projecting from the sprocket body 36. The drive sprocket 20 of this embodiment is preferably formed from moulded plastics material.

Each flexible tooth 38 of the drive sprocket 20 projects radially from the sprocket body 36. A radial extent R of each tooth 38 is equal to or greater than a diameter of the balls 32 of the flexible drive chain 22, and more preferably the radial extent R is equal to or greater than twice a diameter of the balls 32.

A distal projecting end of each tooth 38 includes a cut-out recess 40 in a plane of the tooth 38 in which also lies the rotational axis A of the sprocket 20. The cut-out recess 40, in this case, is U-shaped or V-shaped, but may be of any other suitable shape.

A depth of the cut-out recess 40 is sufficient to allow a ball 32 of the drive chain 22 to be received between adjacent teeth 38 by an amount equal to or more than its diameter. Preferably, a ball 32 of the drive chain 22 can be fully or substantially fully received between adjacent teeth 38, as shown in FIGS. 2, 3 and 5.

The teeth 38, although relatively rigid, flex in a circumferential direction of the sprocket body 36 to accommodate a varying or non-uniform pitch or distance between balls 32 of the drive chain 22 and/or between similar drive chains. This pitch can have a tolerance of up to plus and minus one and a half balls 32, and thus the flexibility of the teeth 38 is sufficient to accommodate this tolerance.

Each tooth 38 does not flex in a direction parallel to the rotational axis A of the drive sprocket 20. Flex only occurs in a direction transverse or lateral to the rotational axis A of the drive sprocket 20.

Each tooth 38 is planar, and as can be best understood from FIG. 4, is a flat plate.

With the drive chain 22 provided in the supporting housing 18, entrained around the drive sprocket 20, and depending from the housing 18 through the guide channels 28, pulling of the chain 22 causes engagement and disengagement of the balls 32 between the teeth 38 of the sprocket 20. As a ball 32 enters a gap between adjacent teeth 38 of the drive sprocket 20, the teeth 38 flex to adapt to the pitch between this ball 32 and the preceding ball 32. In this manner, a load being applied to the drive sprocket 20 via the drive chain 22 is equally distributed through all the balls 32 entrained between the teeth 38 of the drive sprocket 20. The balls 32 thus do not have a tendency to ride up the adjacent teeth 38, and are thus retained between the teeth 38. Rubbing on the interior wall 26 of the housing 18 is consequently eliminated.

Referring now to FIG. 6, a second embodiment of a roller blind mechanism 116 will now be described. The only part that differs in this embodiment is drive sprocket 120, and thus this is the only part which is shown in FIG. 6. Similar parts are referenced with similar numbers, except with ‘100’ added, and thus further detailed description is omitted.

In this embodiment, the drive sprocket 120 is formed from two separate parts 120a and 120b. The sprocket body 136 is typically formed from plastics moulded material, as in the first embodiment, but the teeth 138 are formed separately and may be, for example metal.

Each tooth 138 has an L-shaped longitudinal extent, and the sprocket body 136 includes complementary radially-extending L-shaped recesses 142 equi-angularly formed in spaced apart relationship around a circumference thereof. The recesses 142 are dimensioned to provide a tight interference push-fit engagement with the teeth 138.

As before, each tooth 138 is flexible in a circumferential direction only of the sprocket body 136 in order to accommodate a drive chain having a lower tolerance ball pitch.

Although metal teeth are suggested, the teeth may be formed from any suitable material. The two part drive sprocket is useful when applying the drive sprocket to different sizes of roller blind, which may utilise different sizes of housing, or drive chains with different sizes of balls.

Although a push-fit, the teeth may be engaged in any suitable manner, for example via threaded fastening devices and/or by bonding.

Although the teeth are planar and flat plate shaped, the teeth can be cylindrical, elliptical, or of any non-circular cross-sectional shape.

In a modification to the two embodiments described above, instead of providing planar or substantially planar teeth, one, more or all of the teeth can include a twist in its radial extent. The or each tooth thus takes substantially the form of a blade of a propeller or turbine, in use causing air to be drawn across the drive sprocket, when the drive sprocket is rotated.

This is particularly advantageous for cooling purposes, since heat generated through friction in the roller blind mechanism can cause lubricating material to dry out prematurely.

Although a drive chain having balls is suggested, any suitable elongate flexible drive element having spaced tooth engaging elements can be utilised. For example, the flexible drive element may include open links, instead of balls.

Due to the flexible teeth of the drive sprocket, a drive chain can be utilised which does not need to have a high tolerance tooth-engaging-element pitch. As a result, especially when utilising a stainless steel drive element, costs can be significantly reduced due to the acceptability of a lower accuracy pitch. It is also possible to provide a two part drive sprocket with separate teeth of selectable length, thus allowing application in a variety of sizes of roller blind assemblies. It is further possible to promote air movement across the in use drive sprocket, by providing one or more teeth with a twisted radial extent.

The embodiments described above are given by way of examples only, and various other modifications will be apparent to persons skilled in the art without departing from the scope of the invention, as defined by the appended claims.

1. A roller blind mechanism for winding and unwinding a rollable blind, the mechanism comprising a support element, a drive sprocket which is rotatably mounted on the support element for transmitting rotational movement to a blind supporting member, and a manually-movable elongate flexible drive element which includes a plurality of interlinked tooth-engaging elements, the drive sprocket including a plurality of flexible teeth engagable with the tooth-engaging elements of the flexible drive element.

2. A roller blind mechanism as claimed in claim 1, wherein a radial extent of the teeth of the drive sprocket is equal to or greater than a maximum dimension of the tooth-engaging elements of the flexible drive element.

3. A roller blind mechanism as claimed in claim 2, wherein the radial extent is equal to or greater than twice the maximum dimension of the tooth-engaging elements of the flexible drive element.

4. A roller blind mechanism as claimed in claim 1, wherein the teeth of the drive sprocket flex in a circumferential direction of the sprocket.

5. A roller blind mechanism as claimed in claim 1, wherein the teeth of the drive sprocket are planar or substantially planar and lie in a plane which includes a rotational axis of the sprocket.

6. A roller blind mechanism as claimed in claim 1, wherein a or the pitch between adjacent tooth-engaging elements of the flexible drive element is non-uniform.

7. A roller blind mechanism as claimed in claim 1, wherein the flexible drive element is formed from stainless steel.

8. A roller blind mechanism as claimed in claim 1, wherein a tolerance of a or the pitch between the tooth-engaging elements of the flexible drive element is plus or minus one and a half tooth-engaging element.

9. A roller blind mechanism as claimed in claim 1, wherein the teeth of the drive sprocket flex to accommodate a or the pitch between the tooth-engaging elements of the flexible drive element which is plus or minus one and a half tooth-engaging elements.

10. A roller blind mechanism as claimed in claim 1, wherein the drive sprocket is formed as one-piece.

11. A roller blind mechanism as claimed in claim 1, wherein the drive sprocket includes a sprocket body and the teeth are separate and engaged or engagable with the sprocket body.

12. A roller blind mechanism as claimed in claim 1, wherein one or more of the teeth of the drive sprocket has a twisted radial extent to promote air movement across the in use drive sprocket.

13. A roller blind mechanism as claimed in claim 1, wherein the elongate flexible drive element is a drive chain.

14. A roller blind mechanism as claimed in claim 1, wherein the tooth-engaging elements are balls.

15. A roller blind assembly comprising a sheet of blind material wound around an elongate tubular blind supporting member, a supporting bracket at one end of the blind supporting member by which the blind supporting member is rotatably supported, and a roller blind mechanism as claimed in any one of the preceding claims at the other end for rotating the blind supporting member to wind and unwind the sheet of blind material.
